(19) United States
(12) Patent Application Publication
(10) Pub. No.: US 2011/0090545 A1
(43) Pub. Date: Apr. 21, 2011

(54) Sheet-Feed Scanner Having Multiple Sheed-Feeding Mechanism

(75) Inventor: Yen-Cheng Chen, Hsinchu City (TW)

(73) Assignee: AVISION, INC., Hsinchu (TW)

(21) Appl. No.: 12/643,038

(22) Filed: Dec. 21, 2009

(30) Foreign Application Priority Data
Oct. 16, 2009 (TW) 098135058

(51) Int. Cl. H04N 1/04

(52) U.S. Cl. 358/498

(57) ABSTRACT

The invention discloses a sheet-feed scanner having multiple sheet-feeding mechanisms which includes a paper passage, a first sheet-feeding mechanism, a second sheet-feeding mechanism, a sheet-transporting mechanism and an image-capturing assembly. The first and second sheet-feeding mechanisms feed a sheet of a document into the paper passage, wherein the first sheet-feeding mechanism is disposed at a first end of the paper passage, and the second sheet-feeding mechanism is disposed at a second end of the paper passage. The sheet-transporting mechanism transports the sheet inside the paper passage. The image-capturing assembly is disposed at a side of the paper passage and captures an image of the sheet fed into the paper passage.

### BACKGROUND OF THE INVENTION

1. Field of the Invention

This invention relates to a sheet-feed scanner and more particularly relates to a sheet-feed scanner having multiple sheet-feeding mechanisms.

2. Description of the Prior Art

Generally speaking, an automatic document feeder could be classified into a gravity-type feeder and a pickup-type feeder according to the manner of sheet feeding.

For the usage of the feeders, the gravity-type feeder transports a document or a sheet to the sheet-feeding rollers of the feeder with the aid of gravity. The disadvantage thereof is the limited number of sheets to be carried. If there are excessive sheets stacked at the sheet-feed end, a case of multi-feed occurs easily. The pickup-type feeder is equipped with a pickup roller capable of swinging up and down. The pickup-type feeder picks up the sheet with the pickup roller and transports the sheet to the sheet-feeding rollers thereof. If the surface of the sheet is slippery, e.g. receipts, the pickup roller may not be able to successfully pick up the sheet and transport the sheet to the sheet-feeding rollers, which leads to a case of misfeed. Therefore, each of the gravity-type feeder and the pickup-type feeder has drawbacks of its own which cause troubles for users.

### SUMMARY OF THE INVENTION

The scope of the invention is to provide a sheet-feed scanner having multiple sheet-feeding mechanisms.

According to an embodiment of the invention, a sheet-feed scanner having multiple sheet-feeding mechanisms includes a paper passage, a first sheet-feeding mechanism, a second sheet-feeding mechanism, a sheet-transporting mechanism, and an image-capturing assembly.

The first sheet-feeding mechanism is disposed at a first end of the paper passage. The second sheet-feeding mechanism is disposed at a second end of the paper passage. The first sheet-feeding mechanism and the second sheet-feeding mechanism feed a sheet of a document into the paper passage. The sheet-transporting mechanism transports the sheet inside the paper passage. The image-capturing assembly is disposed at a side of the paper passage for capturing an image of the sheet fed into the paper passage.

In an embodiment, the first sheet-feeding mechanism is a gravity-type sheet-feeding mechanism, and the second sheet-feeding mechanism is a pickup-type sheet-feeding mechanism. The gravity-type sheet-mechanism includes a first separation roller set for picking up the sheet and feeding the sheet singularly into the paper passage. The pickup-type sheet-feeding mechanism includes a pickup roller and a second separation roller set. The pickup roller picks up the sheet to feed the sheet to the second separation roller set. The second separation roller set feeds the sheet singularly into the paper passage.

The sheet-feed scanner having multiple sheet-feeding mechanisms of the invention increases the maximum capacity of stacked sheets to be scanned by combining the gravity-type sheet-feeding mechanism and the pickup-type sheet-feeding mechanism. Further, users can select a proper way of feeding sheets dependent on the attribute of the documents or sheets. For example, if a large volume of sheets is to be processed at once, the sheets may be fed by the pickup-type sheet-feeding mechanism to eliminate the occurrence of multi-feed; if sheets with slippery surface need to be processed, the sheets may be fed by the gravity-type sheet-feeding mechanism to prevent the occurrence of misfeed.

The advantage and spirit of the invention may be understood by the following recitations together with the appended drawings.

### BRIEF DESCRIPTION OF THE APPENDED DRAWINGS

FIG. 1 and FIG. 2 illustrate a sheet-feed scanner according to an embodiment of the invention.

FIG. 3 illustrates another sheet-feed scanner according to another embodiment of the invention.

### DETAILED DESCRIPTION OF THE INVENTION

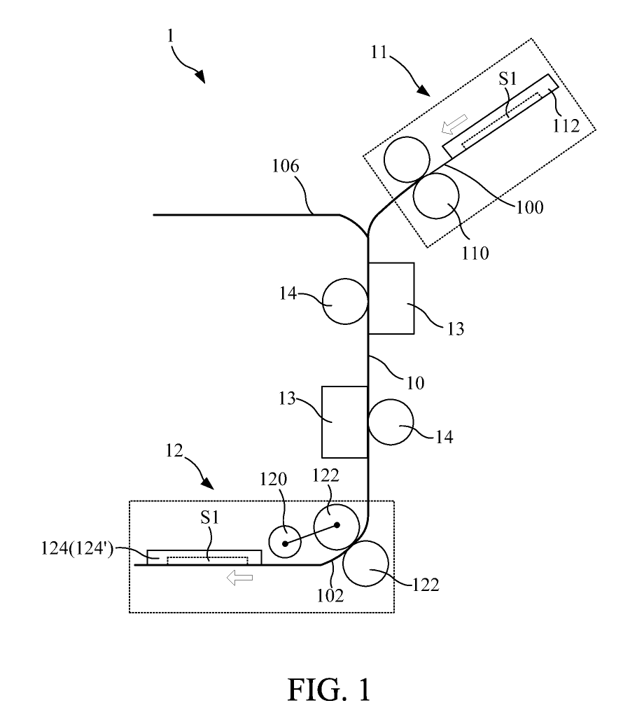

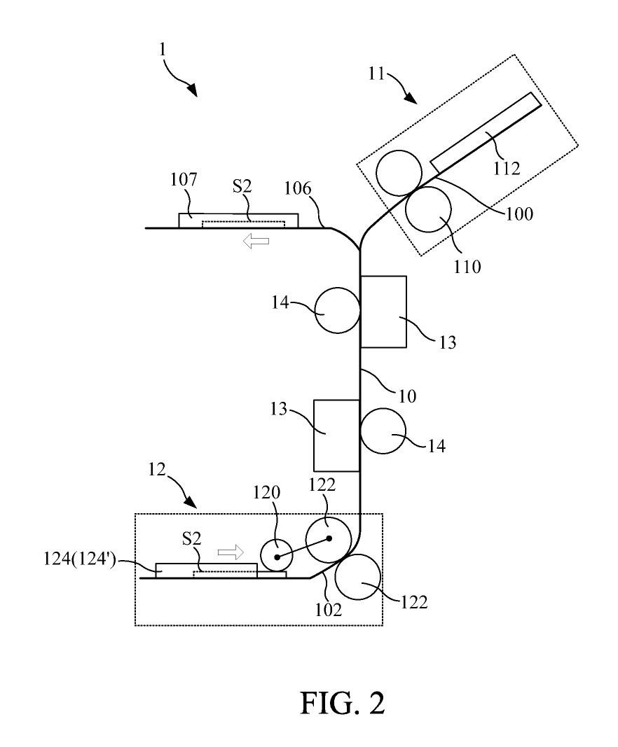

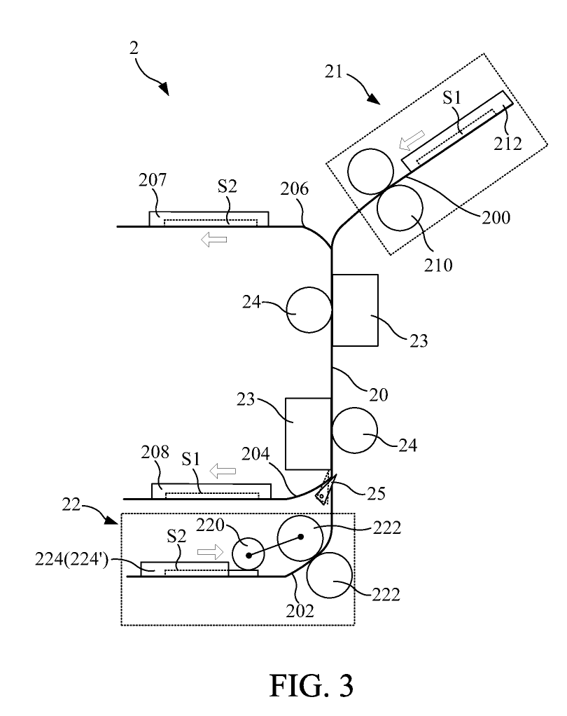

Please refer to FIG. 1 through FIG. 3. FIG. 1 and FIG. 2 illustrate a sheet-feed scanner 1 according to an embodiment of the invention. FIG. 3 illustrates another sheet-feed scanner 2 according to another embodiment of the invention.

As shown in FIG. 1 and FIG. 2, the sheet-feed scanner 1 of the invention includes a paper passage 10, a first sheet-feeding mechanism 11, a second sheet-feeding mechanism 12, a sheet-transporting mechanism 14, and two image-capturing assemblies 13.

The first sheet-feeding mechanism 11 is disposed at a first end 100 of the paper passage 10. The second sheet-feeding mechanism 12 is disposed at a second end 102 of the paper passage 10. In the embodiment shown in FIG. 1 and FIG. 2, the paper passage 10 between the first end 100 and the second end 102 may comprise a vertical sheet-feed path or multiple sheet-feed paths extending in different directions; however, the invention is not limited to this. In relation to the position arrangement of the sheet-feeding mechanisms 11 and 12, in this embodiment, the first sheet-feeding mechanism 11 is disposed at a height higher than the second sheet-feeding mechanism 12.

As for the functionality, both the first sheet-feeding mechanism 11 and the second sheet-feeding mechanism 12 are used for feeding a sheet of a document into the paper passage 10. The sheet-transporting mechanism 14 is used for transporting the sheet inside the paper passage 10. In the embodiment shown in FIG. 1 and FIG. 2, it is taken as an example for illustration that the sheet-feed scanner 1 includes the two image-capturing assemblies 13. The sheet-feed scanner 1 is a double-sided scanner. The two image-capturing assemblies 13 could be disposed at opposite sides of the paper passage 10 respectively and staggered at upper portion and lower portion of the paper passage 10; however, the invention is not limited to this.

When the sheet-transport mechanism 14 transports the sheet past the image-capturing assemblies 13, the image-capturing assemblies 13 capture the images of the sheet. In a practical application, the sheet-feed scanner 1 of the invention scans the image on a single side or images on double sides of the sheet. If the sheet-feed scanner 1 is instructed to scan the image on a single side of the sheet, the sheet-feed scanner 1 controls one of the two image-capturing assemblies 13 to capture the image on the target side of the sheet. If the sheet-feed scanner 1 is instructed to scan the images on the double sides of the sheet, the sheet-feet scanner 1 controls both of the two image-capturing assemblies 13 to capture the images on the double sides of the sheet in turn or at the same time.

It is noticed that, in this embodiment, the first sheet-feeding mechanism 11 is a gravity-type sheet-feeding mechanism, and the second sheet-feeding mechanism 12 is a pickup-type sheet-feeding mechanism.

The first sheet-feeding mechanism 11 includes a first separation roller set 110 for picking up a sheet S1 of a document and feeding the sheet S1 singularly into the paper passage 10. The second sheet-feeding mechanism 12 includes a pickup roller 120 and a second separation roller set 122. The pickup roller 120 picks up the sheet S1 to feed the sheet S1 to the second separation roller set 122. The second separation roller set 122 feeds the sheet S1 singularly into the paper passage 10. The function of the first separation roller set 110 and the second separation roller set 122 is to separate received sheets to make sure that a single sheet is fed into the paper passage 10 one at a time.

In this embodiment, the gravity-type sheet-feeding mechanism is disposed at a height higher than the pickup-type sheet-feeding mechanism.

In addition, the first sheet-feeding mechanism 11 of the sheet-feed scanner 1 of the invention further includes a sheet-input cassette 112 for stacking sheets. As shown in FIG. 1, the sheet-input cassette 112 is slantingly disposed at the first end 100 of the paper passage 10 and at the sheet-feed end of the first sheet-feeding mechanism 11 (gravity-type sheet-feeding mechanism). The sheet S1 stacked in the sheet-input cassette 112 slips into the first separation roller set 110 of the first sheet-feeding mechanism 11 because the sheet-input cassette 112 is aslant, so that the front edge of the sheet S1 is urging against the roller of the first separation roller set 110. Furthermore, the second sheet-feeding mechanism 12 may also include a sheet-input cassette 124 disposed at the second end 102 of the paper passage 10. As shown in FIG. 2, the pickup roller 120 touches the front edge of the sheet S2 stacked in the sheet-input cassette 124. When the scanning operation on the sheet S2 starts, the pickup roller 120 picks up the sheet S2 by the frictional force between the pickup roller 120 and the sheet S2 and then feeds the sheet S2 to the second separation roller set 122.

It is noticed that users may select a proper way of feeding sheets according to the attribute of the documents or sheets in the sheet-feed scanner of the invention. For example, since the quantity of the sheets at the sheet-feed end does not affect the function of the pickup-type sheet-feeding mechanism, if sheets in bulk needs to be processed at once in one scan, the sheets are stacked in the sheet-input cassette 124 of the pickup-type sheet-feeding mechanism 12, the pickup roller 120 then picks up the sheets by the frictional force between the roller and the sheets and transports the sheets to the second separation roller set 122 for sheet separation. However, if the surface of the sheet is slippery, e.g. for the likes of receipts, the pickup roller can not successfully pick up the sheet. In this case, the user can elect to feed the sheet from the gravity-type sheet-feeding mechanism 11. With the aid of the gravity, the sheet slips to the first separation roller set 110 directly for sheet separation.

FIG. 1 illustrates the feeding path of the sheet S1 after being fed from the first sheet-feeding mechanism 11 into the paper passage 10. FIG. 2 illustrates the feeding path of the sheet S2 after being fed from the second sheet-feeding mechanism 12 into the paper passage 10.

In the embodiment shown in FIG. 1, while the sheet-feed scanner 1 of the invention performs the scanning operation on the sheet S1 stacked in the sheet-input cassette 112, the first sheet-feeding mechanism 11 and the sheet-transporting mechanism 14 transport the sheet S1 from the first end 100 of the paper passage 10, past the image-capturing assemblies 13 and then to the second end 102 of the paper passage 10 for paper ejection. In other words, the sheet S1 enters the paper passage 10 through the inlet of the first sheet-feeding mechanism 11, and after being scanned by the image-capturing assemblies 13, the sheet S1 is transported out of the second end 102 of the paper passage 10 and ejected from the inlet of the second sheet-feeding mechanism 12. The second sheet-feeding mechanism 12 could be treated as a sheet-ejecting mechanism. The second sheet-feeding mechanism 12 ejects the sheet S1 out of the paper passage 10 to a sheet-ejection cassette 124′ by rolling the second separation roller set 122 in a reverse direction relative to the rolling direction for feeding sheets into the paper passage 10. While the sheet S1 is ejected from the inlet of the second sheet-feeding mechanism 12, the sheet-input cassette 124 could be treated as a sheet-ejection cassette.

As shown in FIG. 2, As the sheet-feed scanner 1 of the invention executes the scanning operation on the sheet S2 stacked in the sheet-input cassette 124, the second sheet-feeding mechanism 12 and the sheet-transporting mechanism 14 transport the sheet S2 from the second end 102 of the paper passage 10, past the image-capturing assemblies 13 and then to a fourth end 106 of the paper passage 10 to eject the sheet S2 to a sheet-ejection cassette 107. That is, the sheet S2 fed into the paper passage 10 from the second sheet-feeding mechanism 12 may be ejected from an individual outlet (i.e. the fourth end 106).

In the another embodiment shown in FIG. 3, the sheet-feed scanner 2 includes a paper passage 20, a first sheet-feeding mechanism 21, a second sheet-feeding mechanism 22, a sheet-transporting mechanism 24, and two image-capturing assemblies 23. The first sheet-feeding mechanism 21 includes a first separation roller set 210. The second sheet-feeding mechanism 22 includes a pickup roller 220 and a second separation roller set 222. The paper passage 20 includes a first end 200 where the first sheet-feeding mechanism 21 is disposed, a second end where the second sheet-feeding mechanism 22 is disposed, a third end 204, and a fourth end 206. The fourth end 206 is treated as a sheet-ejection outlet for the sheet S2 being ejected from the paper passage 20. Compared with the sheet-feed scanner 1 in FIG. 1, the sheet-feed scanner 2 according to this embodiment further includes the third end 204 at a height lower than the first end 200 to be a sheet-ejection outlet for the sheet S1 being ejected from the paper passage 20.

As the sheet-feed scanner 2 executes the scanning operation on the sheet S1 stacked in the sheet-input cassette 212, the first sheet-feeding mechanism 21 and the sheet-transporting mechanism 24 transport the sheet S1 from the first end 200 of the paper passage 20, past the image-capturing assemblies 23 and then to the third end 204 of the paper passage 20 to eject the sheet S1 to a sheet-ejection cassette 208. The advantage of disposing a sheet-ejection outlet (i.e. the third end 204) is that when the sheet-feed scanner 2 performs the scanning operation on the sheet S1 stacked in the first sheet-feeding mechanism 21, a user may place the sheet S2 in the sheet-input cassette 224 to be fed into the paper passage 20 through the second sheet-feeding mechanism 22 without waiting for the sheet-feed scanner 2 completing the scanning operation on the sheet S1.

Alternatively, the sheet S1 enters the paper passage 20 through the inlet of the first sheet-feeding mechanism 21, and after being scanned by the image-capturing assemblies 23, the sheet S1 may be fed out of the second end 202 of the paper passage 20 and ejected from the inlet of the second sheet-feeding mechanism 22. The second sheet-feeding mechanism 22 could be treated as a sheet-ejecting mechanism. The second sheet-feeding mechanism 22 ejects the sheet S1 out of the paper passage 20 to a sheet-ejection cassette 224′ by rolling the second separation roller set 222 in a reverse direction relative to the rolling direction for feeding sheets into the paper passage 20. When the sheet S1 is ejected from the inlet of the second sheet-feeding mechanism 22, the sheet-input cassette 224 could be treated as a sheet-ejection cassette.

The sheet-feed scanner 2 may further include a movable sheet-guiding component 25, e.g. swing lever, disposed in the paper passage 20. The sheet-feed scanner 2 controls the swinging of the movable sheet-guiding component 25 to guide the sheet S1 to the second end 202 or to the third end 204 for paper ejection according to different sheet-feed modes. Similarly, a device like the movable sheet-guiding component 25 could also be disposed at the fork for the first end 200 and the fourth end 206 so as to guide the sheet S2 to the fourth end 206 for paper ejection, so that the sheet S2 is prevented from entering the first sheet-feeding mechanism 21 at the first end 200.

Furthermore, when the sheet-feed scanner 2 performs the scanning operation on the sheet S2 stacked in the sheet-input cassette 224, the second sheet-feeding mechanism 22 and the sheet-transporting mechanism 24 transport the sheet S2 from the second end 202 of the paper passage 20, past the image-capturing assemblies 23 and then to the fourth end 206 of the paper passage 20 to eject the sheet S2 to a sheet-ejection cassette 207. That is, the sheet S2 fed into the paper passage 20 from the second sheet-feeding mechanism 22 could be ejected from an individual outlet (i.e. the fourth end 206).

With the example and explanations above, the features and spirits of the invention will be hopefully well described. Those skilled in the art will readily observe that numerous modifications and alterations of the device may be made while retaining the features and spirit of the invention. Accordingly, the above disclosure should be construed as limited only by the metes and bounds of the appended claims.

What is claimed is:

1. A sheet-feed scanner having multiple sheet-feeding mechanisms, comprising:
a paper passage;
a first sheet-feeding mechanism, for feeding a sheet of a document into the paper passage;
a second sheet-feeding mechanism, for feeding the sheet into the paper passage, wherein the first sheet-feeding mechanism is disposed at a first end of the paper passage, and the second sheet-feeding mechanism is disposed at a second end of the paper passage;
a sheet-transporting mechanism, for transporting the sheet inside the paper passage; and
an image-capturing assembly, disposed at a side of the paper passage for capturing an image of the sheet fed into the paper passage.

2. The sheet-feed scanner of claim 1, wherein the first sheet-feeding mechanism is disposed at a height higher than the second sheet-feeding mechanism.

3. The sheet-feed scanner of claim 1, wherein the first sheet-feeding mechanism is a gravity-type sheet-feeding mechanism and comprises a first separation roller set for picking up the sheet and feeding the sheet singularly into the paper passage, the second sheet-feeding mechanism is a pickup-type sheet-feeding mechanism and comprises a pickup roller and a second separation roller set, the pickup roller picks up the sheet to feed the sheet to the second separation roller set, and the second separation roller set feeds the sheet singularly into the paper passage.

4. The sheet-feed scanner of claim 3, wherein the first sheet-feeding mechanism is disposed at a height higher than the second sheet-feeding mechanism.

5. The sheet-feed scanner of claim 3, further comprising a sheet-input cassette slantingly disposed at the first end of the paper passage, a front edge of the sheet stacked in the sheet-input cassette being urging against the first separation roller set.

6. The sheet-feed scanner of claim 1, wherein the first sheet-feeding mechanism and the sheet-transporting mechanism transport the sheet from the first end of the paper passage, past the image-capturing assembly and then to the second end of the paper passage for paper ejection.

7. The sheet-feed scanner of claim 1, wherein the first sheet-feeding mechanism and the sheet-transporting mechanism transport the sheet from the first end of the paper passage, past the image-capturing assembly and then to a third end of the paper passage for paper ejection.

8. The sheet-feed scanner of claim 7, further comprising a movable sheet-guiding component disposed in the paper passage for guiding the sheet to the second end or the third end for paper ejection.

9. The sheet-feed scanner of claim 1, wherein the second sheet-feeding mechanism and the sheet-transporting mechanism transport the sheet from the second end of the paper passage, past the image-capturing assembly and then to a fourth end of the paper passage for paper ejection.
